(19) United States
(12) Patent Application Publication
(10) Pub. No.: US 2009/0227331 A1
(43) Pub. Date: Sep. 10, 2009

(54) GAMING MACHINE PERFORMING ANOTHER ACTION TO FURTHER DETERMINE AN AWARD IF A SPECIFIED SYMBOL IS DISPLAYED IN A PREDETERMINED AREA

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/210,408

(22) Filed: Sep. 15, 2008

Related U.S. Application Data
(60) Provisional application No. 61/034,421, filed on Mar. 6, 2008.

(51) Int. Cl. A63F 9/24; A63F 13/00

(52) U.S. Cl. 463/20; 463/30

(57) ABSTRACT

A gaming machine 10 executes following operations: starting a basic game; starting scrolling of symbols; determining a symbol to stationarily display; rearranging the determined symbol; in a case where a combination of the symbols matches a predetermined condition, providing a first award to a player; in a case where a specified symbol is rearranged within a predetermined area and a symbol for providing a second award is rearranged around the predetermined area, newly displaying a symbol selection image for selecting a symbol; moving the newly displayed symbol selection image by sequentially displaying around the predetermined area; and in a case where the symbol for providing the second award has been rearranged at a position where the symbol selection image has been stopped, providing the second award to the player.

### CROSS REFERENCE TO RELATED APPLICATIONS

This application claims benefit of U.S. Provisional Application No. 61/034,421, filed Mar. 6, 2008, the entire contents of which are incorporated herein by reference.

### BACKGROUND OF THE INVENTION

1. Field of the Invention

The present invention relates to a gaming machine which performs another action for further determining an award when a specified symbol is displayed at a predetermined area.

2. Related Art

It is known that conventional slot machines start a game when a predetermined amount of credit is bet and then a plurality of reels, on which a plurality of symbols are depicted, start to rotate and the rotations of the plurality of the reels stop after a predetermined period of time elapses. As a result, an award is provided to a player based on a displayed stationary symbol combination. U.S. Pat. No. 6,517,433 discloses that, to improve a shortcoming of common expressions lacking dynamism on a display, a video display is provided in front of rotatable reels to provide a video image superimposed upon the rotatable reels thereby displaying visual effects including information associated with games correlating with the images of reels, whereby novel and powerful effects are produced in games.

However, although the slot machine described above produces novel and powerful effects in a game by providing the video display, the method of determining an award is still the same as that of the conventional slot machines and the game tends to lack in variety. Thus, a gaming machine which can arouse a player's interest by exhibiting a new method of determining an award that has not existed thus far is anticipated.

The present invention provides a gaming machine with new entertainment properties which provides an award based on a combination of stationary symbols displayed and provides another award by performing another action for further determining an award when a specified symbol is displayed within a predetermined area, whereby the gaming machine can arouse a player's interest, and enhance excitement.

### SUMMARY OF THE INVENTION

In a first aspect of the present invention, a gaming machine includes: a display for displaying a plurality of symbols used in a game; an input device for starting a basic game; and a controller configured to execute the following processing of: (a) generating a random number in response to an input to the input device, and starting a basic game; (b) starting scrolling of the symbols displayed on the display; (c) determining a symbol corresponding to the random number generated, to stationarily display on the display; (d) rearranging the determined symbol corresponding to the processing of (c), by displaying a symbol stationarily on the display; (e) providing a first award to a player playing the game in a case where a combination of the rearranged symbols matches a predetermined condition; (f) aside from providing the first award, newly displaying a symbol selection image for selecting a symbol on the display in a case where a specified symbol is rearranged within a predetermined area of the display and a symbol for providing a second award is rearranged around the predetermined area; (g) moving the displayed symbol selection image by sequentially displaying the newly displayed symbol selection image on each of the symbols rearranged around the predetermined area; (h) stopping the movement of the symbol selection image; and (i) providing the second award to the player playing the game in a case where the symbol for providing the second award has been ed at the position where the movement of the symbol selection image has been stopped.

The gaming machine according to the first aspect of the present invention is configured to execute following operations: (a) generating a random number in response to an input to the input device, and starting a basic game; (b) starting scrolling of the symbols displayed on the display; (c) determining a symbol corresponding to the random number generated, to stationarily display on the display; (d) rearranging the determined symbol corresponding to the processing of (c), by displaying a symbol stationarily on the display; (e) providing a first award to a player playing the game in a case where a combination of ed symbols matches a predetermined condition; (f) aside from providing the first award, newly displaying a symbol selection image for selecting a symbol on the display in a case where a specified symbol is rearranged ed within the predetermined area of the display and the symbol for providing a second award is rearranged around the predetermined area; (g) moving the displayed symbol selection image by sequentially displaying the newly displayed symbol selection image on each of the symbols rearranged around the predetermined area; (h) stopping the movement of the symbol selection image; and (i) providing the second award to the player playing the game in a case where the symbol for providing the second award has been rearranged at the position where the movement of the symbol selection image has been stopped.

In a second aspect of the present invention, a gaming machine includes: a display for displaying a plurality of symbols used in a game; an input device for starting a basic game; and a controller configured to execute the following processing of: (a) generating a random number in response to an input to the input device, and starting a basic game; (b) starting scrolling of the symbols displayed on the display; (c) determining a symbol corresponding to the random number generated, to stationarily display on the display; (d) rearranged ing the determined symbol corresponding to the processing of (c), by displaying a symbol stationarily on the display; (e) providing a first award to a player playing the game in a case where a combination of the rearranged symbols matches the predetermined condition; (f) aside from providing the first award, newly displaying a symbol selection image for selecting a symbol on the display in a case where a specified symbol is rearranged within a predetermined area of the display and the symbol for providing a second award is rearranged around the predetermined area; (g) newly generating a random number after the processing of (f); (h) moving the displayed symbol selection image by sequentially displaying the newly displayed symbol selection image on each of the symbols rearranged around the predetermined area; (i) stopping the movement of the symbol selection image according to the random number thus newly generated; and (j) providing the second award to the player playing the game in a case where the symbol for providing the second award has been rearranged at the position where the movement of the symbol selection image has been stopped.

The gaming machine according to the second aspect of the present invention is configured to execute the following operations: (a) generating a random number in response to an input to the input device, and starting a basic game; (b) starting scrolling of the symbols displayed on the display; (c) determining a symbol corresponding to the random number thus generated, to stationarily display on the display; (d) rearranging the determined symbol corresponding to the processing of (c), by displaying a symbol stationarily on the display; (e) providing a first award to a player playing the game in a case where a combination of the rearranged symbols matches the predetermined condition; and (f) aside from providing the first award, newly displaying a symbol selection image for selecting a symbol on the display in a case where a specified symbol is rearranged within a predetermined area of the display and the symbol for providing a second award is rearranged around the predetermined area; (g) newly generating a random number after the processing of (f); (h) moving the displayed symbol selection image by sequentially displaying the newly displayed symbol selection image on each of the symbols rearranged around the predetermined area; (i) stopping the movement of the symbol selection image according to the random number thus newly generated; and (j) providing the second award to the player playing the game in a case where the symbol for providing the second award has been rearranged at the position where the movement of the symbol selection image has been stopped.

### BRIEF DESCRIPTION OF THE DRAWINGS

FIG. 1 is a diagram showing characteristics of the gaming machine according to an embodiment of the present invention;

FIG. 2 is a perspective view showing an appearance of the gaming machine according to the embodiment of the present invention;

FIG. 3 is an enlarged front view showing a display area of the gaming machine according to the embodiment of the present invention;

FIG. 4 is a block diagram of a controller of the gaming machine according to the embodiment of the present invention;

FIG. 5 is a block diagram of a display control device of the gaming machine according to the embodiment of the present invention;

FIG. 6 is a diagram showing a symbol data table for a first award according to the embodiment of the present invention;

FIG. 7 is a diagram showing a symbol layout table according to the embodiment of the present invention;

FIG. 8 is a flowchart showing basic game processing executed in the gaming machine according to the embodiment of the present invention;

FIG. 9 is a flowchart showing processing of providing a second award according to the embodiment of the present invention;

FIG. 10 is a first example of a display screen of a game displayed by the gaming machine according to the embodiment of the present invention;

FIG. 11 is an example of the display screen continued from FIG. 10;

FIG. 12 is an example of the display screen continued from FIG. 11;

FIG. 13 is an example of the display screen continued from FIG. 12;

FIG. 14 is a diagram showing a symbol selection image movement table according to the embodiment of the present invention;

FIG. 15 is a diagram showing a second example of the display screen of the game displayed by the gaming machine according to the embodiment of the present invention;

FIG. 16 is a diagram showing an area table for rearranging a specified symbol according to the embodiment of the present invention; and

FIG. 17 is a diagram showing a third example of the display screen of the game displayed by the gaming machine according to the embodiment of the present invention.

### DETAILED DESCRIPTION OF THE INVENTION

The embodiments of the present invention are hereinafter described with reference to the attached drawings.

A gaming machine 10 according to the present invention includes a start switch 25 and CPU 106 which executes the following operation of: (a) generating a random number in response to an input to the start switch 25, and starting a basic game; (b) starting scrolling of symbols displayed on the liquid crystal display 30; (c) determining a symbol to stationarily display corresponding to the random number thus generated; (d) rearranging the symbol thus determined by displaying a symbol stationarily on the liquid crystal display 30; (e) providing a first award to a player in a case where a combination of the rearranged symbols matches a predetermined condition, (f) aside from providing the first award, newly displaying a symbol selection image for selecting a symbol on the liquid crystal display 30 in a case where a specified symbol (for example, a sun symbol 94) is rearranged within a predetermined area of the liquid crystal display 30 and the symbol for providing a second award is rearranged around the predetermined area; (g) moving the displayed symbol selection image by sequentially displaying the newly displayed symbol selection image on each of the symbols rearranged around the predetermined area; (h) stopping the movement of the symbol selection image; and (i) providing the second award to the player playing the game in a case where the symbol for providing the second award has been rearranged at the position where the movement of the symbol selection image has been stopped.

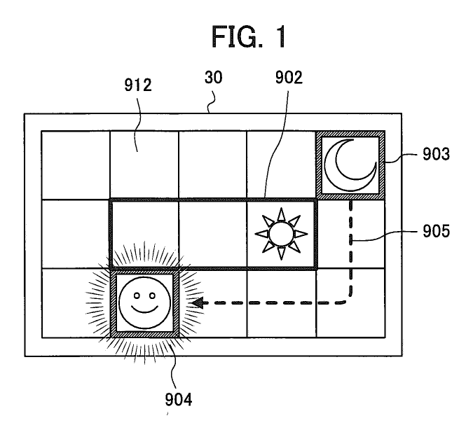

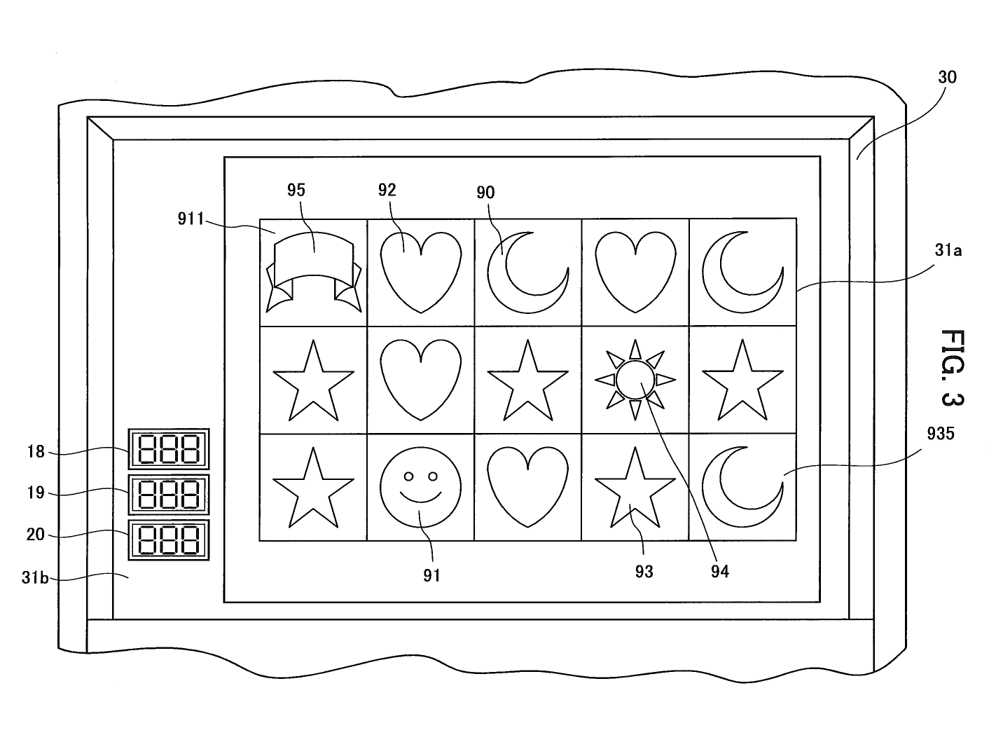

FIG. 1 is a diagram showing the characteristics of the gaming machine 10 according to an embodiment of the present invention. In FIG. 1, 30 indicates a display for displaying a plurality of symbols used in a game and 912 indicates a cell positioned at the first row and the second column of a display screen 31a (which is described later referring to FIG. 3), where the symbols are to be rearranged. The gaming machine 10 according to the present invention, upon starting a basic game, rearranges the symbols in the cells, and provides a first award to a player in a case where a combination of the rearranged symbols matches a predetermined condition. Furthermore, the gaming machine 10 according to the present invention newly displays a symbol selection image (for example, a shaded frame 903 in FIG. 1) in a case where a specified symbol (for example, a sun symbol 94) is rearranged within a predetermined area (for example, the area indicated by a thick line frame 902 in FIG. 1) and the symbol for providing a second award (for example, a smile symbol 91) is rearranged around the predetermined area, moves the symbol selection image (for example, the movement indicated by the broken line 905 shown in FIG. 1), and then stops the movement. Subsequently, the gaming machine 10 according to the present invention provides the second award in a case where the symbol for providing the second award (for example, the smile symbol 91) is rearranged at the position where the movement of the symbol selection image has been stopped. Thus, the gaming machine 10 according to the present invention provides an award based on a combination of rearranged symbols, and in a case where the specified symbol is rearranged within a predetermined area and a symbol for providing a second award is rearranged, further performs another action for providing another award, and, based on the action, provides another award thereby providing with new entertainment properties that can arouse a player's interest and enhance excitement.

### First Embodiment

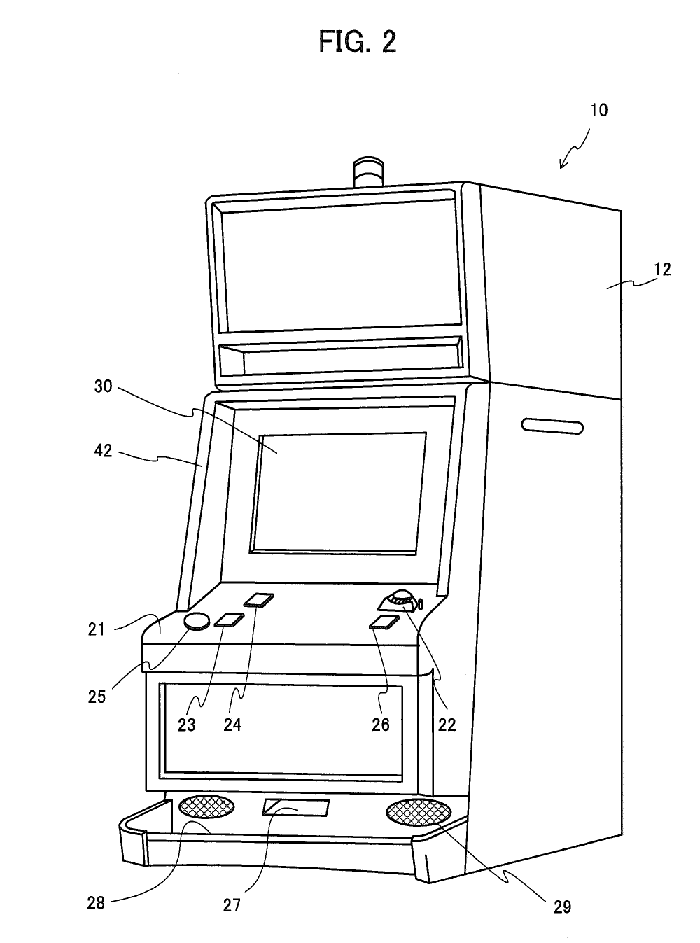

FIG. 2 is a perspective view showing an appearance of the gaming machine 10 according to the embodiment of the present invention.

The gaming machine 10 according to the embodiment of the present invention is described with reference to FIG. 2.

The gaming machine 10 includes a cabinet 12 and a main door 42.

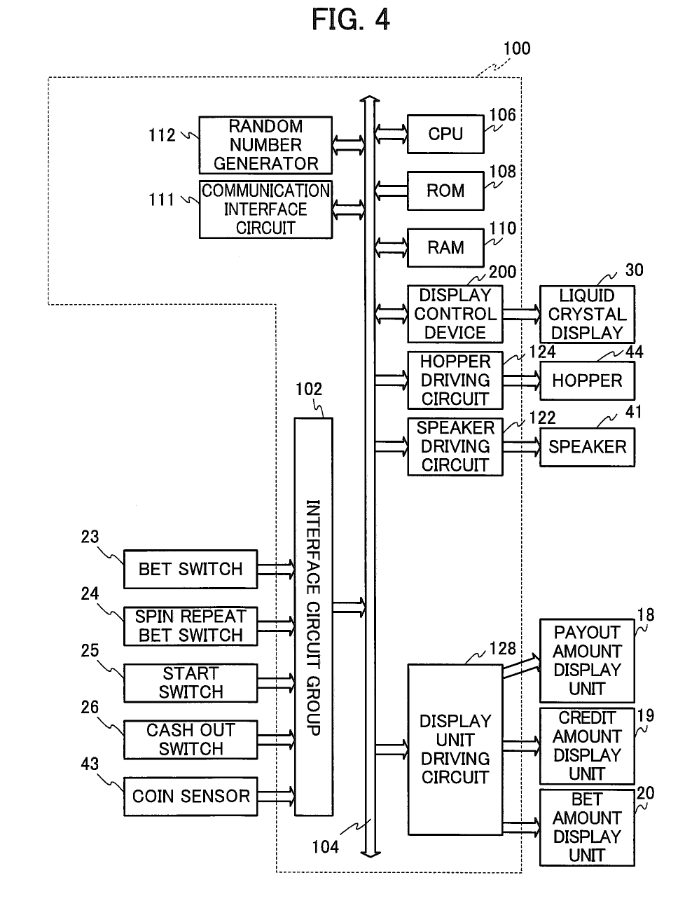

The cabinet 12, which has a surface open to a player, is installed in a certain place of a casino, for example. The cabinet 12 contains various kinds of constructional members, including members such as a controller 100 (see FIG. 4) for electrically controlling the gaming machine 10, and a hopper 44 (see FIG. 4) for controlling the inserting, storing and paying of coins (game media).

The main door 42 serves as a member which covers the cabinet 12 so as to protect the inside components of the cabinet 12 from being exposed to the outside. The main door 42 is attached to a left side of the cabinet 12 about an axis as seen from the front side, so that the door 42 swings about the axis in the forward and backward directions, and settles in either a selectable open or closed positions. The liquid crystal display 30 is disposed substantially in the center of the main door 42.

The liquid crystal display 30 is a display means for displaying various kinds of images associated with a game, and a player advances the game while visually confirming the various kinds of images thus displayed on the liquid crystal display 30. It should be noted that a detailed description regarding the configuration of the liquid crystal display 30 is given later.

A substantially horizontal operation unit 21 is provided below the liquid crystal display 30. A coin insertion opening 22, which allows the player to insert coins into the gaming machine 10, is provided on the right side of the operation unit 21. On the other hand, a bet switch 23 for selecting the amount of coins to bet on a single game and a spin repeat bet switch 24 for playing the subsequent game without changing the amount of coins to bet from the amount of coins bet in a previous game are disposed on the left side of the operation unit 21. Such an arrangement allows the player to determine the amount of coins to bet on a single game by pushing either the bet switch 23 or the spin repeat bet switch 24.

A start switch 25 is disposed on the left side of the bet switch 23 on the operation panel 21. At the start of each game, the start switch 25 receives an instruction given by the player for starting a game. A push operation on either the start switch 25 or the spin repeat bet switch 24 triggers starting the game.

A payout switch 26 is disposed adjacent to the coin insertion slot 22 on the operation panel 21. Upon push operation of the payout switch 26 by the player, coins in the gaming machine 10 are paid out through a coin payout opening 27 disposed at the lower portion of the front face of the main door 42 into a coin tray 28. Sound outlets 29 for conveying sound effects generated by speakers 41 (see FIG. 3), which are contained inside of the cabinet 12, to the outside of the cabinet 12, are disposed on both the right and left sides of the coin payout opening 27 above the coin tray 28.

Moreover, it should be noted that, although the gaming machine 10 according to the present embodiment employs a coin as a game medium, the game medium is not limited thereto, and any kind of game medium, such as cash, a medal, a token, electronic money, a ticket, an IC card, and the like, may be used, for example.

FIG. 3 is an enlarged front view showing a display area of the gaming machine 10 according to the embodiment of the present invention.

The liquid crystal display 30 is described with reference to FIG. 3.

The liquid crystal display 30 is configured with a publicly known liquid crystal display, and has a display screen 31a and a display screen 31b. The display screen 31a displays cells 911 to 935 arranged in a matrix. The display screen 31b includes a payout amount display unit 18, a credit amount display unit 19, and a bet amount display unit 20. The cells 911 to 935 are basic units of the display arranged in a matrix provided on the display screen 31a.

The display screen 31a displays the cells 911 to 935 which are divided into a matrix of three rows and five columns. Here, the cell 911 indicates the cell at row 1 and column 1, and the cell 935 indicates the cell at row 3 and the column 5. On each of the cells 911 to 935, symbol data of moon symbols 90, a smile symbol 91, heart symbols 92, star symbols 93, a sun symbol 94, and a ribbon symbol 95 are displayed.

The payout amount display unit 18 displays an amount of an award to be paid out when a combination of stationary symbols displayed on the display screen 31a matches a predetermined combination. The credit amount display unit 19 displays the credit amount which the player currently possesses. The bet amount display unit 20 displays the amount of coins bet by the player (a bet amount) on a single game. Each of the display units 18 to 20 includes a seven-segment display. Alternatively, the display units 18 to 20 may be used for displaying images.

FIG. 4 is a block diagram of a controller of the gaming machine 10 according to the embodiment of the present invention.

The electric configuration of the gaming machine 10 is described with reference to FIG. 4.

The abovementioned controller 100 is a microcomputer, which includes an interface circuit group 102, an input/output bus 104, a CPU 106, ROM 108, RAM 110, a communication interface circuit 111, a random number generator 112, a speaker driving circuit 122, a hopper driving circuit 124, a display unit driving circuit 128, and a display control device 200.

The interface circuit group 102 is electrically connected with the input/output bus 104, which inputs and outputs data signals or address signals to and from the CPU 106.

The start switch 25 is electrically connected with the interface circuit group 102. The start signal generated by the start switch 25 is converted into a predetermined form of signal in the interface circuit group 102, to be supplied to the input/output bus 104.

The bet switch 23, the spin repeat bet switch 24, and the payout switch 26 are also electrically connected with the interface circuit group 102. Each of the switching signals output from these switches 23, 24, and 26 is also supplied to the interface circuit group 102, and is converted into a predetermined form of signal by the interface circuit group 102, and the switching signals thus converted are subsequently supplied to the input/output bus 104.

A coin sensor 43 is also electrically connected with the interface circuit group 102. The coin sensor 43 which is disposed at an appropriate position relative to the coin insertion slot 22 is a sensor for detecting detects coins inserted into the coin insertion slot 22. The sensing signal output from the coin sensor 43 is also supplied to the interface circuit group 102, and is converted into a predetermined form of signal by the interface circuit group 102, and the sensing signal thus converted is subsequently supplied to the input/output bus 104.

Furthermore, the ROM 108 and the RAM 110 are connected to the input/output bus 104.

Upon accepting an instruction for starting a basic game via the start switch 25, the CPU 106 reads a game program and performs a basic game.

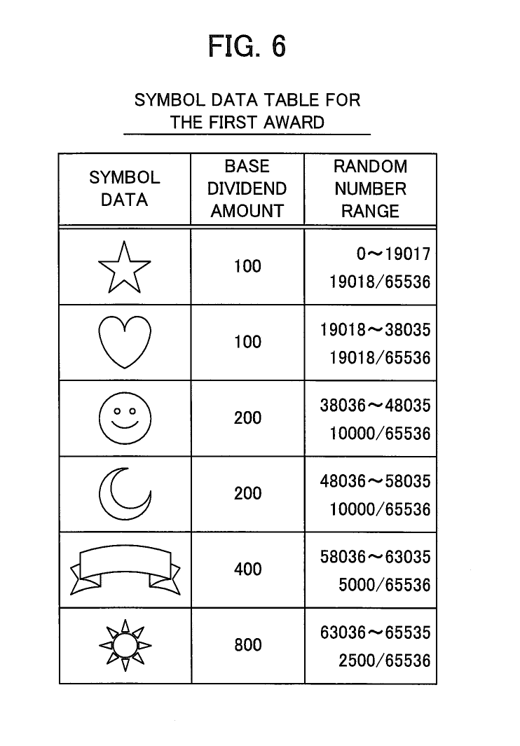

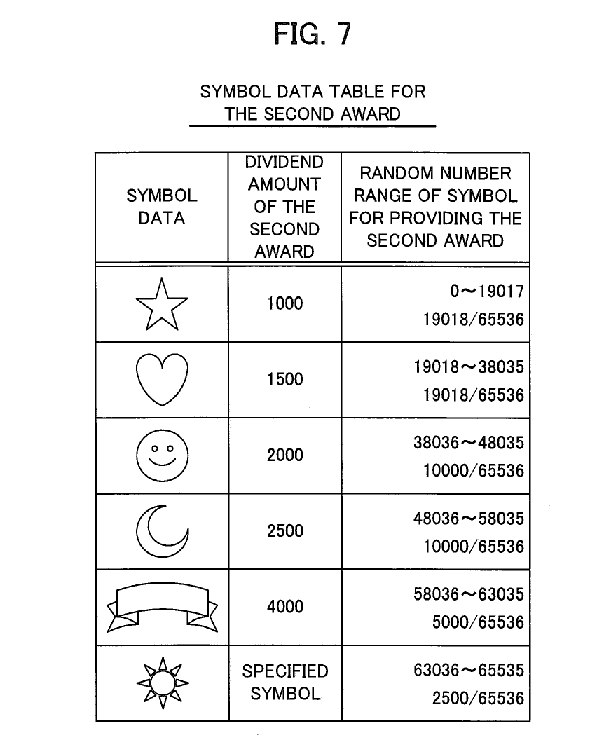

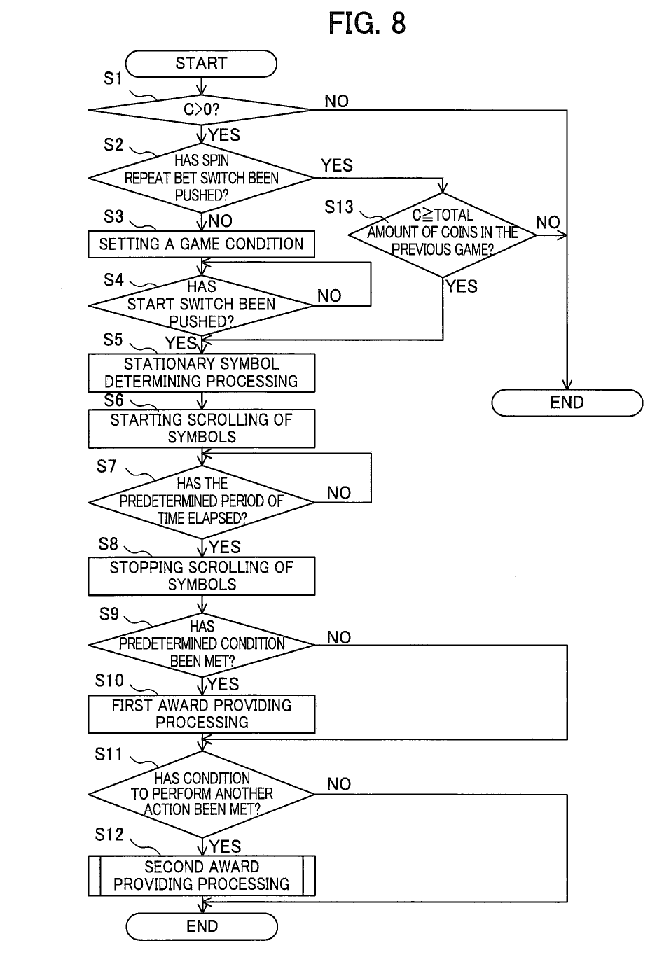

The ROM 108 stores a control program for centrally controlling the gaming machine 10, a program for executing the routines shown in FIG. 8 (hereinafter referred to as routine execution program”), initial data for executing the control program, and various data tables. The routine executing program includes the abovementioned first award providing processing, the second award providing processing, and the like. The tables shown in FIGS. 6 and 7 are examples of data tables.

The RAM 110 temporarily stores flags, variables, and the like used for the abovementioned control program.

The communication interface circuit 111 is also connected to the input/output bus 104. The communication interface circuit 111 communicates with a server and the like via various kinds of communication networks, including a public telephone line network, a LAN, and the like.

The random number generator 112 for generating a random number is also connected to the input/output bus 104. The random number generator 112 generates random numbers in a predetermined range of for example, 0 to 65535 (two to the sixteenth power minus one). Alternatively, random numbers may be configured to be generated by the processing of the CPU 106.

The display unit driving circuit 128 for driving the abovementioned various display units 18 to 20 is electrically connected with the input/output bus 104. The CPU 106 controls the various display units 18 to 20 via the display unit driving circuit 128 in response to occurrences of predetermined events.

The speaker driving circuit 122 for driving the speakers 41 is also electrically connected with the input/output bus 104. The CPU 106 reads sound data stored in the ROM 108, and transmits the sound data thus read to the speaker driving circuit 122 via the input/output bus 104. In this way, the speakers 41 generates predetermined sound effects.

The hopper driving circuit 124 for driving the hopper 44 is also electrically connected with the input/output bus 104. The CPU 106 outputs a driving signal to the hopper driving circuit 124 via the input/output bus 104 in response to receiving a payout signal from the payout switch 26. Accordingly, the hopper 44 pays out amount of coins equivalent to the current amount of credits remaining, which is stored in a predetermined memory area of the RAM 110.

The display control device 200 is also electrically connected with the input/output bus 104. The CPU 106 generates an instruction for displaying an image according to the status and outcome of a game and outputs an instruction for displaying images thus generated to the display control device 200 via the input/output bus 104. Upon reception of an image display instruction input from the CPU 106, the display control device 200 generates a driving signal for driving the liquid crystal display 30 according to the image display instruction thus input, and outputs the generated driving signal to the liquid crystal display 30.

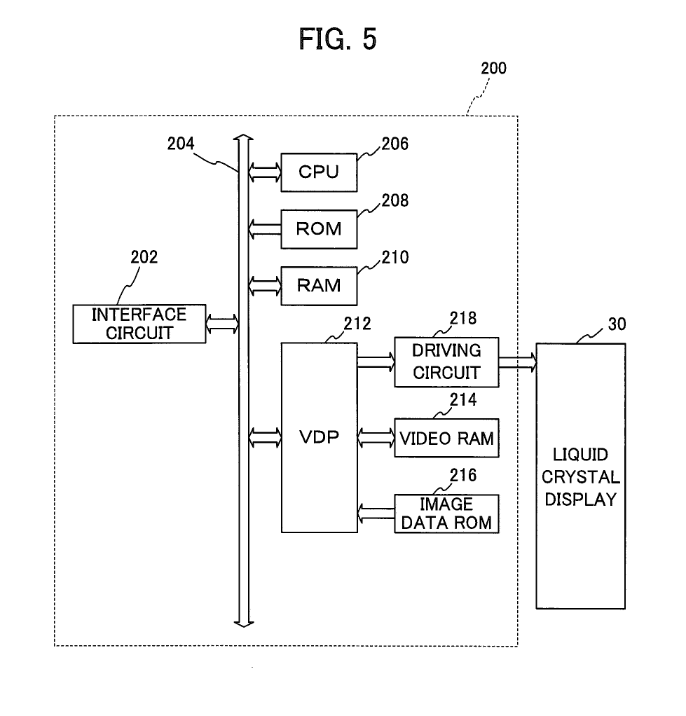

FIG. 5 is a block diagram of a display control device of the gaming machine 10 according to the embodiment of the present invention. The electrical configuration of the display control device 200 is described with reference to FIG. 5.

The abovementioned display control device 200 is a sub-microcomputer for performing image displaying processing, and includes an interface circuit 202, an input/output bus 204, a CPU 206, ROM 208, RAM 210, a VDP 212, video RAM 214, image data ROM 216, and a driving circuit 218.

The interface circuit 202 is connected to the input/output bus 204. An instruction for displaying an image generated by the CPU 106 of the controller 100 is output to the input/output bus 204 via the interface circuit 202. The input/output bus 204 inputs and outputs data signals and address signals to and from the CPU 206.

The ROM 208 and the RAM 210 are also connected to the input/output bus 204. The ROM 208 stores a display control program for generating a driving signal to be supplied to the liquid crystal display 30, according to an image display instruction received from the CPU 106 included in the abovementioned controller 100. On the other hand, the RAM 210 stores flags and variables used by the abovementioned program for controlling display. The VDP 212 is also connected to the input/output bus 204. The VDP 212 includes a so-called sprite circuit, a screen circuit, a palette circuit, and the like, and can execute various kinds of processing for displaying images on the liquid crystal display 30. The video RAM 214 for storing the image data according to an instruction from the CPU 106 of the controller 100, and the image data ROM 216 for storing various image data (including image data of symbols) are connected with the VDP 212. Further, the driving circuit 218 for outputting a driving signal for driving the liquid crystal display 30 is also connected to the VDP 212.

The CPU 206 reads the image data of various symbols from the image data ROM 216 via the VDP 212 in response to receiving an instruction for displaying the image from the CPU 106 of the controller 100, and stores the data thus read to the predetermined memory area of the video RAM 214 which corresponds to the displaying position. The CPU 206 supplies these data to the driving circuit 218 as display signals via the VDP 212, whereby cells 911 to 935 are displayed on the display screen 31a. In addition, the CPU 206 sequentially rewrites the image data of symbols to be stored in the video RAM 214 via the VDP 212, whereby the symbols to be displayed in the cells 911 to 935 are rotatably displayed on the display screen 31a.

As explained above, it is understood that various processing described in the appended claims are executed by the controller 100 which includes the CPU 106 for executing various kinds of controls in accordance with the program stored in the ROM 108 for storing the routine execution program, the RAM 110 for serving as a working area for CPU 106, and the display control device 200 for controlling driving of the liquid crystal display 30. In other words, the controller 100 serves as an example of a game controller.

FIG. 6 is a diagram showing a symbol data table for the first award according to the embodiment of the present invention. The symbol data table for the first award includes columns of “Symbol Data”, “Base Dividend Amount”, and “Random Number Range”.

“Symbol Data” shows the symbol data that is to be rearranged in cells 911 to 935 on the display screen 31a. “Base Dividend Amount” shows a dividend amount that is to be provided to a player in a case where a combination of the symbol data matches a predetermined condition. The dividend amount that is to be provided when the symbols represented by the symbol data form adjacent arrangement is one example. An adjacent arrangement is formed in a case where identical symbol data is rearranged in one of the cells (for example, a cell 922) and also in an immediately adjacent cell which lies on one of the upper side (for example, a cell 912), the lower side (for example, a cell 932), the left side (for example, a cell 921) and the right side (for example, a cell 923) of the cell. In other words, the adjacent arrangement is formed when identical symbol data is rearranged in two or more than two adjacent cells. The dividend amount is determined by the base dividend amount multiplied by the number of cells forming the adjacent arrangement. For example, when symbols represented by three identical symbol data form an adjacent arrangement, the dividend amount equals a base dividend amount multiplied by three. “Random Number Range” shows a range of random numbers for rearranging symbol data in cells 911 to 935 corresponding to a random number generated.

FIG. 7 is a diagram showing a symbol data table for a second award according to the embodiment of the present invention. The symbol data table for the second award includes columns of “Symbol Data”, “Dividend Amount of the Second Award”, and “Random Number Range of Symbol for providing second award”.

“Symbol Data” shows the symbol data that is to be rearranged in cells 911 to 935 on the display screen 31a. “Dividend Amount of the Second Award” shows the dividend amount provided in a case where the condition for providing the second award is met supposing the “Symbol Data” is the symbol for providing the second award. “Random Number Range” shows the range of the random number which determines the symbol data for providing the second award, corresponding to the random number generated. For example, the smile symbol 91 can be the symbol for providing the second award in accordance with a generated random number. In this case, when the sun symbol 94 is rearranged at the predetermined area as the specified symbol and the smile symbol 91 is rearranged around the predetermined area, the CPU 106 newly displays the symbol selection image and subsequently moves the symbol selection image. In a case where the smile symbol 91 is rearranged at the position where the symbol selection image has been stopped, then the dividend amount of 2000 is provided as the second award.

FIG. 8 is a flowchart showing basic game processing executed in the gaming machine 10 according to the embodiment of the present invention. The routine of FIG. 8 is a unit game.

It is supposed that the gaming machine 10 is activated in advance, and that the variables used in the CPU 106 on the controller 100 are initialized to predetermined values, whereby the gaming machine 10 is operated in a normal state.

The CPU 106 of the controller 100 determines whether or not there are remaining credits, which are remaining coins inserted by a player (Step S1). More specifically, the CPU 106 reads a credit amount C stored in the RAM 110, and executes processing according to the credit amount C thus read. In a case where the credit amount C equals “0” (“NO” in the determination processing in Step S1), the CPU 106 terminates the routine without executing any other processing, since the game cannot be started. On the other hand, in a case where the credit amount C is not less than “1” (“YES” in the determination processing in Step S1), the CPU 106 determines that there is a remaining credit, and the CPU 106 advances the processing to Step S2.

In Step S2, the CPU 106 determines whether or not a pushing operation has been executed on the spin repeat bet switch 24. In a case where the spin repeat bet switch 24 has been pushed and the CPU 106 receives an operation signal from the spin repeat bet switch 24 (“YES” in the determination processing in Step S2), the CPU 106 advances the processing to Step S13. On the other hand, in a case where the CPU 106 does not receive the operation signal from the spin repeat bet switch 24 after the predetermined period of time elapses (“NO” in the determination processing in Step S2), the CPU 106 determines that the spin repeat bet switch 24 has not been pushed and advances the processing to Step S3.

In the following Step S3, the CPU 106 sets the game conditions. Specifically, the CPU 106 determines the amount of coins to bet in the present game based on the operation of the bet switch 23. The CPU 106 reads the credit amount C stored in a predetermined memory area of the RAM 110, subtracts the total bet amount, which is the sum of the bet amounts, from the credit amount C thus read, and stores the subtracted value in a predetermined memory area of the RAM 110. Subsequently, the CPU 106 advances the processing to Step S4.

In the following Step S4, the CPU 106 waits for the start switch 25 to be operated by determining whether or not the start switch 25 has been activated. Upon the start switch 25 being operated, and accordingly, upon the operation signal being input from the start switch 25 (“YES” in the determination processing in Step S4), the CPU 106 determines that the start switch 25 has been operated, and the CPU 106 advances the processing to Step S5.

On the other hand, in Step S13, the CPU 106 determines whether or not the credit amount C is equal to or greater than the total bet amount in a previous game. In other words, the CPU 106 determines whether or not the CPU 106 can start a game in response to a pushing operation executed on the spin repeat bet switch 24. Specifically, when the spin repeat bet switch 24 has been pushed, and the operation signal has been input to the CPU 106 from the spin repeat bet switch 24, the CPU 106 reads the credit amount C and the credit amount bet in the previous game stored in the RAM 110. Then, the CPU 106 determines whether or not the credit amount C is equal to or greater than the total credit amount bet in the previous game based on the relation between the credit amount C and the bet amounts thus read, and executes processing based on the determination results. In a case where the CPU 106 determines that the abovementioned credit amount C is less than the total bet amount in the previous game (“NO” in the determination processing in Step S13), the CPU 106 terminates the routine without executing any other processing since the CPU 106 cannot start a game. On the other hand, in a case where the CPU 106 determines that the credit amount C is equal to or greater than the total bet amount in the previous game (“YES” in the determination processing in Step S13), the CPU 106 subtracts the total bet amount in the previous game from the credit amount C, and stores the subtracted value in a predetermined area of the RAM 110. Subsequently, the CPU 106 advances the processing to Step S5.

In Step S5, the CPU 106 executes processing for determining a stationary symbol.

Specifically, the CPU 106 extracts a random number from the random number generator 112. Based on the symbol data table for the first award, the CPU 106 determines symbols to arrange in each of cells 911 to 935 with the extracted random number (0 to 65535), and accordingly, determines the symbol for providing the second award, then stores the symbol thus determined in the RAM 110. Subsequently, the CPU 106 advances the processing to Step S6.

In Step S6, the CPU 106 executes the scrolling display of the symbols in cells 911 to 935. Specifically, the CPU 106 executes the scrolling display of the symbols in the cells 911 to 935 sequentially or simultaneously, based on the symbol stored in the abovementioned RAM 110. Subsequently, the CPU 106 the advances processing to Step S7.

In Step S7, the CPU 106 waits for a predetermined period of time to elapse, and when the predetermined period of time has elapsed (“YES” in the determination processing in Step S7), the CPU 106 advances the processing to Step S8.

In the following Step S8, the CPU 106 terminates the scrolling of the symbols and advances the processing to Step S9.

In Step S9, the CPU 106 determines whether or not the predetermined condition has been met. Specifically, the CPU 106 determines whether or not an adjacent arrangement has been formed for each symbol, and in a case where the CPU 106 determines that an adjacent arrangement has been formed, the CPU 106 advances the processing to Step S10, and in a case where the CPU determines that an adjacent arrangement has not been formed, the CPU 106 advances the processing to Step S11.

In Step S10, the CPU 106 executes a processing for providing the first award. Specifically, the CPU 106 counts the number of cells forming an adjacent arrangement for each of the symbol data, calculates the award based on the symbol data table for the first award, and provides the award. Subsequently, the CPU 106 advances the processing to Step S11.

In step S11, the CPU 106 determines whether or not the condition for performing another action has been met. Specifically, the CPU 106 rearranges the specified symbol within the predetermined area, and subsequently determines whether or not the symbol for providing the second award has been rearranged around the predetermined area. In a case where the CPU 106 determines that the condition for performing another action has been met, the CPU 106 advances the processing to Step S12, and in a case where the CPU 106 determines that the condition for performing another action has not been met, the CPU 106 terminates the routine.

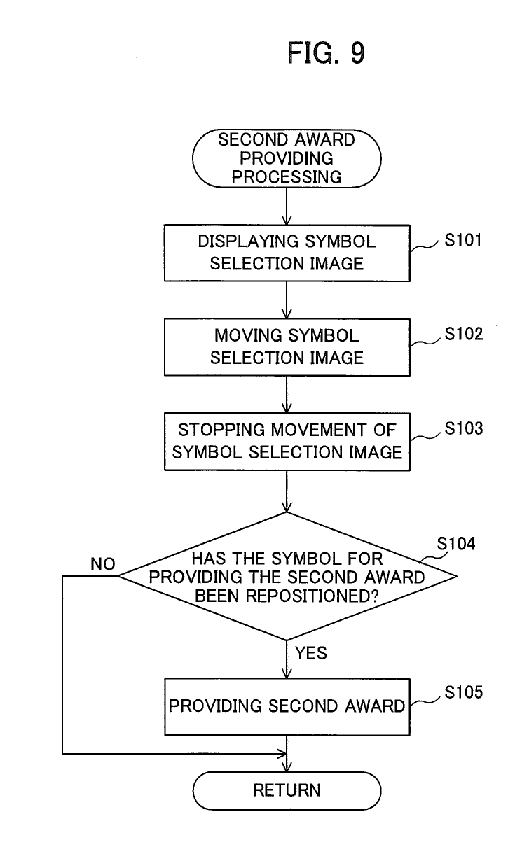

In step S12, the CPU 106 executes processing for providing the second award. Specifically, the CPU 106 advances the processing to the processing of providing the second award (see FIG. 9), and terminates the routine.

FIG. 9 is a flowchart for processing of providing the second award executed by the gaming machine 10 according to the embodiment of the present invention.

Firstly, the CPU 106 displays a symbol selection image (Step S101), and advances the processing to Step S102. In Step S102, the CPU 106 advances the symbol selection image and advances the processing to Step S3. In the following Step S103, the CPU 106 stops the movement of the symbol selection image and advances the processing to Step S104. In Step S104, the CPU 106 determines whether or not the symbol displayed at a position in cells 911 to 935 where the symbol selection image has stopped is the symbol for providing the second award. In a case where the CPU 106 determines that the symbol displayed is the symbol for providing the second award, the CPU 106 advances the processing to Step S105, and in a case where the CPU 106 determines that the symbol displayed is not the symbol for providing the second award, the CPU 106 terminates the processing, then executes the processing, and returns to the next step of the second award providing processing (Step S12) in the basic game processing routine. In Step S105, the CPU 105 executes the processing of providing the second award, terminates the processing thereof, executes the processing, and returns to the next step of the second award providing processing (Step S12) in the basic game processing routine.

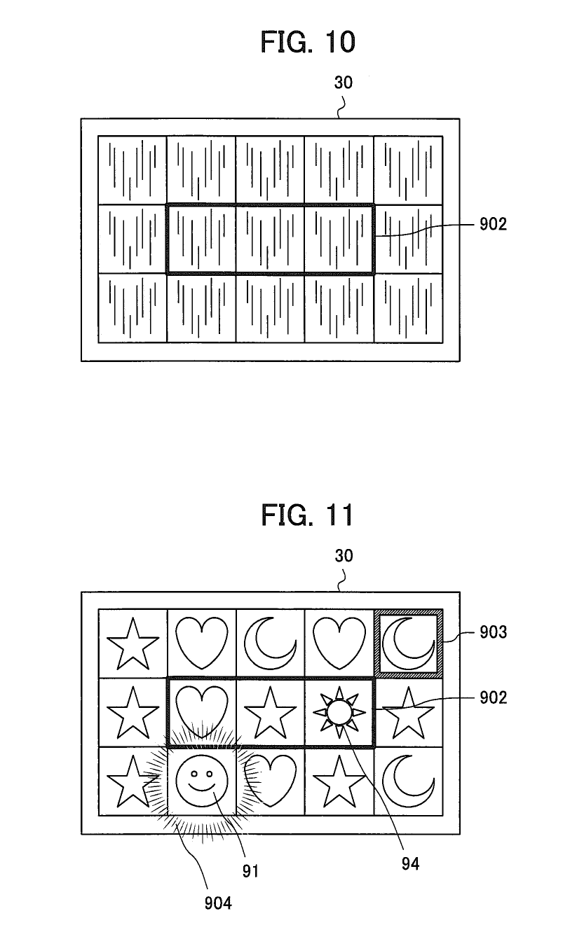

FIG. 10 is a first example of a display screen of a game displayed by the gaming machine 10 according to the embodiment of the present invention. In the example described here, it is supposed that the specified symbol is the sun symbol 94 and the symbol for providing the second award is the smile symbol 91.

FIG. 10 shows that symbols have been displayed in the cells 911 to 935 on the liquid crystal display 30, that the basic game has been started in response to input of an instruction for starting the game, that a random number has been generated, that a stationary symbol has been determined together with a symbol for providing the second award, and that a scrolling display of the symbols is being executed in each of cells 911 to 935. FIG. 10 also shows that the bold line frame 902 indicates the predetermined area.

FIG. 11 is an example of the display screen continued from FIG. 10.

FIG. 11 shows that the symbols have been rearranged in the cells 911 to 935 on the liquid crystal display 30 and that a first award has been provided, since the rearranged symbols form an adjacent arrangement (the star symbols 93 have been arranged adjacently in the cells 911, 921 and 931, and the heart symbols 92 have been arranged adjacently in the cells 912 and 922). Furthermore, FIG. 11 shows that the sun symbol 94, which is the specified symbol, has been rearranged in the cell 924 positioned within the area surrounded by the bold line frame 902 and the smile symbol 91, which is the symbol for providing the second award, has been rearranged in the cell 932 positioned around the bold line frame 902, whereby the shaded frame 903 is being newly displayed as the symbol selection image. In addition, FIG. 11 shows that the smile symbol 91 is being marked by a mark 904, since a second award is provided in a case where the shaded frame 903 moves and stops at the smile symbol 91.

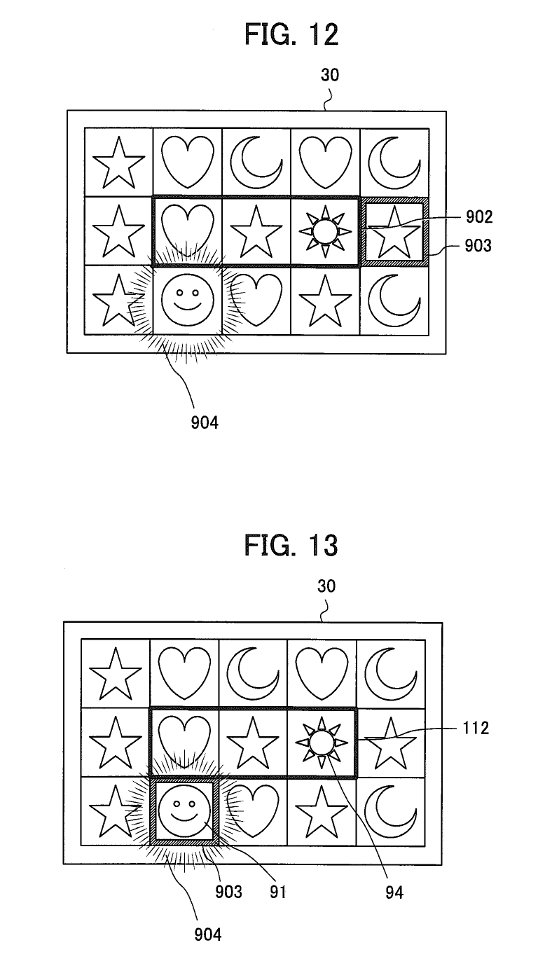

FIG. 12 is an example of the display screen continued from FIG. 11.

FIG. 12 shows that the shaded frame 903, which is the symbol selection image, has been moved to the cell 925 positioned one cell below.

FIG. 13 is an example of the display screen continued from FIG. 12.

FIG. 13 shows that the shaded frame 903, which is the symbol selection image, has been stopped, and the smile symbol 91, which is the symbol for providing the second award, has been rearranged ed at the cell 932 where the shaded frame 903 has stopped, whereby the second award is being provided.

### Second Embodiment

In the second embodiment, a random number is newly generated after a symbol selection image for selecting a symbol is newly displayed on the display.

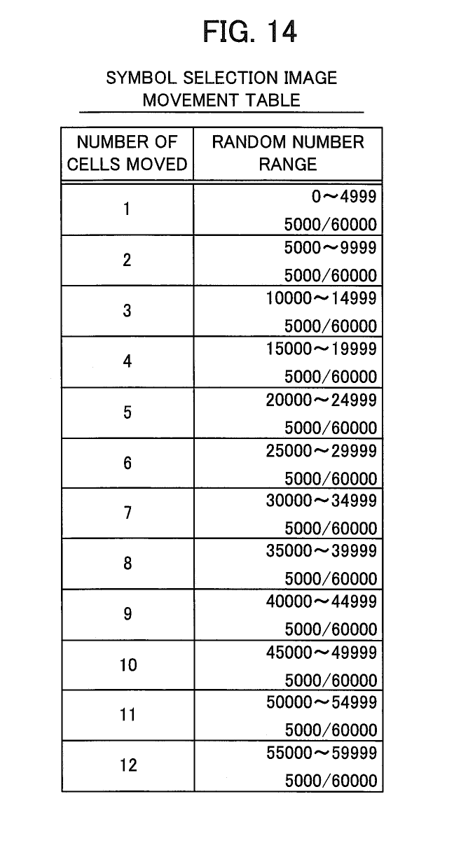

FIG. 14 is a diagram showing a symbol selection image movement table according to the embodiment of the present invention.

The symbol selection image movement table includes columns of “Number of Cells Moved” and “Random Number Range”. “Number of Cells Moved” indicates the number of cells over which the symbol selection image has been moved. “Random Number Range” indicates the range for the random number newly generated. The number of cells over which the symbol selection image moves is determined based on the random number table for the symbol selection image with the random number thus generated.

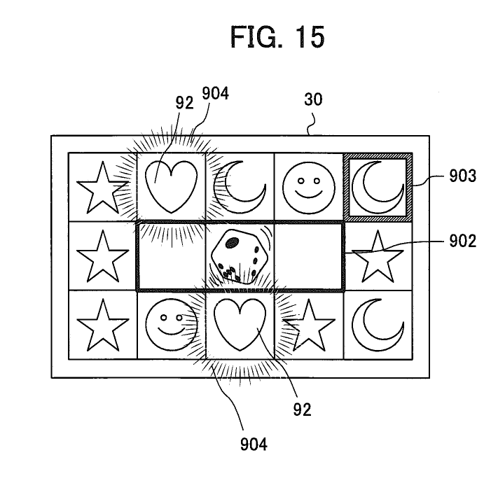

FIG. 15 is a diagram showing a second example of the display screen of the game displayed by the gaming machine 10 according to the embodiment of the present invention.

FIG. 15 shows a state in which symbols have been rearranged ed in the cells 911 to 935 on the liquid crystal display 30, a first award has been provided, a specified symbol (for example, the sun symbol 94) has been rearranged within the bold line frame 902, and the heart symbol 92, which is the symbol for providing the second award, has been rearranged in the cells 912 and 933 around the bold line frame 902, whereby the shaded frame 903 has been newly displayed as a symbol selection image and a random number is being newly generated. The shaded frame 903 is moved based on the random number thus generated, and in a case where a symbol for providing the second award has been rearranged at a position where the symbol selection image has been stopped among cells 911 to 935 (for example, the shaded image 903 has been stopped over cell 912 or cell 933), the second award is provided.

By the abovementioned configuration, a chance of providing the second award is provided according to a result of newly generating a random number, whereby the gaming machine 10 can further arouse a player's interest and enhance the player's excitement while the random number is being generated.

### Third Embodiment

In a third embodiment of the present invention, the gaming machine 10 determines a predetermined area based on a dividend amount of a first award.

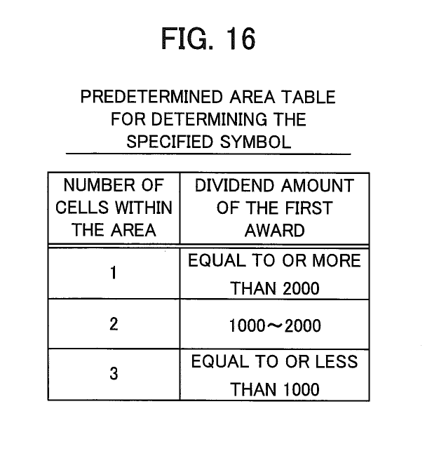

FIG. 16 is a diagram showing an area table for determining a specified symbol according to the embodiment of the present invention.

The area table includes columns of “Number of cells within the area” and “Dividend amount of the first award”. “Number of Cells within the Area” indicates that the number of cells within the predetermined area for determining whether or not the specified symbol has been rearranged. “Dividend Amount of the First Award” indicates that the dividend amount provided as a first award. The number of cells within the predetermined area for determining whether or not the specified symbol has been rearranged is determined based on the area table with the dividend amount of the first award. The cell to be positioned in the predetermined area is determined among cells 922 to 924 based on the number of cells within the area thus determined. In a case where the number of cells within the area thus determined is 1, one of the cells among the cell 921, the cell 922 and the cell 923 is determined as the cell to be positioned within the predetermined area, based on the random number. Furthermore, in a case where the number of cells within the area thus determined is 2, either the cells 921 and 922, or the cells 922 and the cell 923 are determined as the cells positioned within the predetermined area based on the random number. Subsequently, the specified symbol is rearranged within the predetermined area, and whether or not the symbol for providing the second award has been rearranged around the predetermined area is determined. In a case where the condition met, another action for providing the second award is performed.

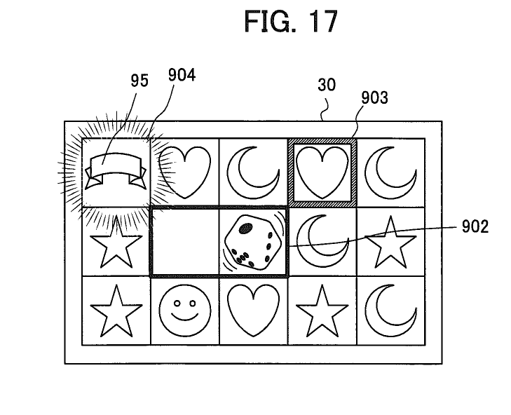

FIG. 17 is a diagram showing a third example of a display screen of the game displayed by the gaming machine 10 according to the embodiment of the present invention.

FIG. 17 shows an example in which symbols are rearranged in the cells 911 to 935 on the liquid crystal display 30, a first award is provided, and a predetermined area for determining the second award according to the first award is determined.

The example shows that a bold line frame 902 is set in cells 921 and 922 according to a first award. In a case where the specified symbol (for example, the sun symbol 94) is rearranged and the symbol for providing the second award is rearranged around the bold line frame 902 (cells 911 to 914, cells 914 to 934, cells 934 to 931, and cells 931 to 911 are the cells positioned around the bold line frame 902, and the cells on the fifth column, which are cells 915 to 935, are not included), another action is performed for providing the second award.

The predetermined area may be enlarged in a case where the dividend of the first award is high, and the predetermined area may be reduced in a case where the dividend of the first award is low or none. According to the first award, the player's interest can be aroused, and excitement can be enhanced.

On the other hand, the predetermined area may be reduced in a case where the dividend of the first award is high, and the predetermined area may be enlarged in a case where the dividend of the first award is low or none. Although the dividend of the first award is low, there is a chance that a second award will be provided, whereby the player's interest can be aroused and the excitement is enhanced.

In the present embodiment, cells on the display screen are configured with video-based reels, but may also be configured with mechanical reels. Another action for providing the second award can be performed by disposing a transparent liquid crystal display in front of a mechanical reel.

While the embodiments of the gaming machine 10 according to the present invention have been described above, it should be clearly understood that the embodiments in no way restrict the present invention, and that the specific configurations such as the means and members may be modified and altered as suitable. Moreover, it should be understood that the advantages described in association with the embodiments are merely a listing of the most preferred advantages, and that the advantages of the present invention are by no means restricted to those described in connection with the embodiments.

What is claimed is:

1. A gaming machine, comprising:
a display for displaying a plurality of symbols used in a game;
an input device for starting a basic game;
and a controller configured to execute the following processing of:
(a) generating a random number in response to an input to the input device, and starting a basic game;
(b) starting scrolling of the symbols displayed on the display;
(c) determining a symbol corresponding to the random number generated to stationarily display on the display;
(d) rearranging the determined symbol corresponding to the processing of (c), by displaying a symbol stationarily on the display;
(e) providing a first award to a player playing the game in a case where a combination of the rearranged symbols matches a predetermined condition;
(f) aside from providing the first award, newly displaying a symbol selection image for selecting a symbol on the display in a case where a specified symbol is rearranged within a predetermined area of the display and a symbol for providing a second award is rearranged around the predetermined area;
(g) moving the displayed symbol selection image by sequentially displaying the newly displayed symbol selection image on each of the symbols rearranged around the predetermined area;
(h) stopping the movement of the symbol selection image; and
(i) providing the second award to the player playing the game in a case where the symbol for providing the second award has been rearranged at the position where the movement of the symbol selection image has been stopped.

2. A gaming machine, comprising:
a display for displaying a plurality of symbols used in a game;
an input device for starting a basic game;
and a controller configured to execute the following processing of:
(a) generating a random number in response to an input to the input device, and starting a basic game;
(b) starting scrolling of the symbols displayed on the display;
(c) determining a symbol corresponding to the random number generated, to stationarily display on the display;
(d) rearranging the determined symbol corresponding to the processing of (c) by displaying a symbol stationarily on the display;
(e) providing a first award to a player playing the game in a case where a combination of the rearranged symbols matches a predetermined condition;
(f) aside from providing the first award, newly displaying a symbol selection image for selecting a symbol on the display in a case where a specified symbol is rearranged within a predetermined area of the display and the symbol for providing a second award is rearranged around the predetermined area;
(g) newly generating a random number after the processing of (f);
(h) moving the displayed symbol selection image by sequentially displaying the newly displayed symbol selection image on each of the symbols rearranged around the predetermined area;
(i) stopping the movement of the symbol selection image according to the random number thus newly generated; and
(j) providing the second award to the player playing the game in a case where the symbol for providing the second award has been rearranged at the position where the movement of the symbol selection image has been stopped.
